(19) United States
(12) Patent Application Publication
(10) Pub. No.: US 2008/0142619 A1
(43) Pub. Date: Jun. 19, 2008

(54) Spray washer nozzle integrated with housing for vehicle

(75) Inventor: Choong Yeul Kim, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/784,413

(22) Filed: Apr. 6, 2007

(30) Foreign Application Priority Data
Dec. 15, 2006 (KR) 10-2006-0128897

(51) Int. Cl. B60S 1/52; B08B 3/02

(52) U.S. Cl. 239/284.1

(57) ABSTRACT

The present invention relates to a spray washer nozzle structure for a vehicle. The spray washer nozzle structure includes: a housing installed to a hood panel or a cowl top cover of a vehicle; and a spray washer nozzle integrally formed with the housing for supplying toward the windshield glass of a vehicle a cleaning solution received from the housing.

### CROSS-REFERENCE TO RELATED APPLICATION

This application claims priority to and the benefit of Korean Patent Application No. 10-2006-0128897 filed on Dec. 15, 2006, the entire contents of which are incorporated herein by reference.

### BACKGROUND OF THE INVENTION

(a) Field of the Invention

The present invention relates to a spray washer nozzle structure for a vehicle, and more particularly to a spray washer nozzle structure in which a spray nozzle is integrally formed with a housing, thereby improving the overall spray performance.

(b) Background Art

A washer nozzle for a vehicle should be able to spray a small amount of a cleaning solution in a wide area for a short time. Various types of washer nozzle have been developed and are used.

In a three-way type washer nozzle among them, a separate washer nozzle is rotatably coupled to a housing, and a cleaning solution is sprayed in three ways. Although the three-way type washer nozzle has advantages that the manufacturing costs are low and the spray angle can be controlled, it has a drawback that the cleansing solution is not uniformly sprayed and cleaning performance is thus reduced.

A two-layer spray type washer nozzle is used in order to enhance the cleaning performance. In the two-layer spray type washer nozzle, a separate washer nozzle is fixed to a housing, and a cleaning solution is sprayed in two layers. Although the two-layer spray type washer nozzle has advantages that the cleaning solution can be sprayed uniformly in a wide range, the spray angle cannot be controlled and the manufacturing costs are high.

### SUMMARY OF THE INVENTION

The present invention has been made in an effort to provide a spray washer nozzle structure which has low manufacturing costs and can spray a cleansing solution uniformly in a wide range so as to enhance the overall cleaning performance.

An exemplary embodiment of the present invention provides a spray washer nozzle integrated with a housing including: a housing which is installed to a hood panel or a cowl top cover of a vehicle and supplies cleaning solution; and a spray washer nozzle which is integrally formed with the housing and supplies the cleaning solution toward a windshield glass.

In one aspect, the present invention provides a spray washer nozzle structure comprising: a housing installed to a hood panel or a cowl top cover of a vehicle; and a spray washer nozzle integrally formed with the housing for supplying toward the windshield glass of a vehicle a cleaning solution received from the housing.

In a preferred embodiment, the spray washer nozzle may comprise: a nozzle body in which the cleaning solution flows; a cleaning solution inlet formed at a side of the nozzle body for introducing the cleaning solution into the nozzle body; and a main spray part formed at the other side of the nozzle body opposite to the cleaning solution inlet for spraying the cleaning solution.

In another preferred embodiment, the spray washer nozzle may further comprise a split part formed in a shape of a semicircle between the cleaning solution inlet and the main spray part for splitting the cleaning solution to both sides of the nozzle body.

Preferably, the spray washer nozzle may further comprise a sub spray part formed between the split part and both sides of the nozzle body.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present spray washer nozzles will be particularly useful with a wide variety of motor vehicles.

Other aspects of the invention are discussed infra.

### BRIEF DESCRIPTION OF THE DRAWINGS

FIG. 1 is an exploded perspective view of a spray washer nozzle structure according to an exemplary embodiment of the present invention.

FIG. 2 is cross sectional view of a spray washer nozzle structure according to an exemplary embodiment of the present invention.

FIG. 3 is a top plan view of a washer nozzle structure according to an exemplary embodiment of the present invention.

Reference numerals set forth in the Drawings includes reference to the following elements as further discussed below:
1: housing
10: washer nozzle
100: nozzle body
110: cleaning solution inlet
120: main spray part
130: split part
140: sub spray part
150: guiding part
200: hood panel

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

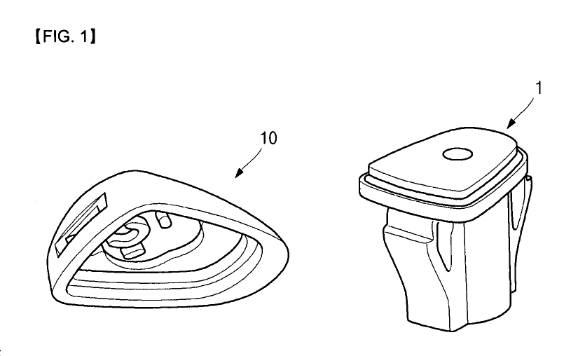

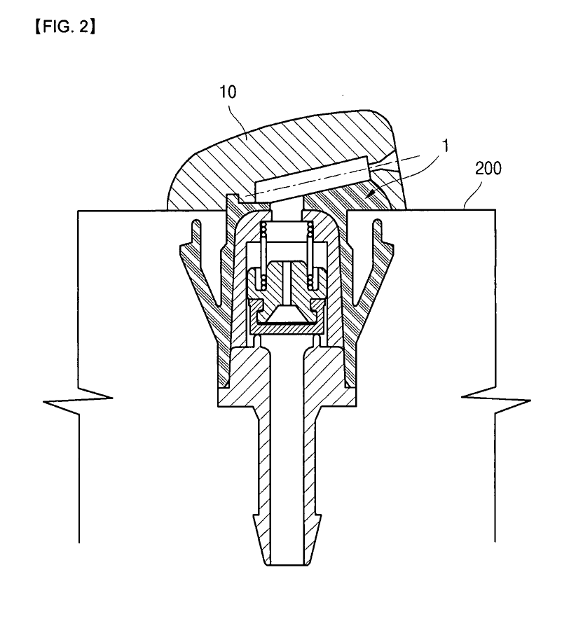

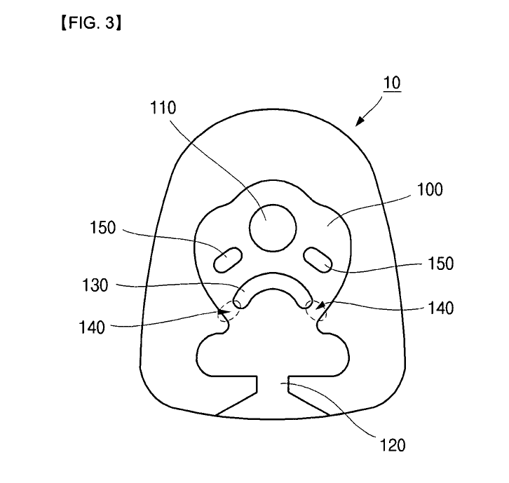

FIG. 1 is an exploded perspective view of a spray washer nozzle structure according to an exemplary embodiment of the present invention, FIG. 2 is cross sectional view of a spray washer nozzle structure according to an exemplary embodiment of the present invention, and FIG. 3 is a top plan view of a washer nozzle structure according to an exemplary embodiment of the present invention.

As shown in FIG. 1 and FIG. 2, a housing 1 which is installed to a hood panel 200 or a cowl top cover of a vehicle. A spray washer nozzle 10 is integrally formed with the housing 1. The housing 1 supplies a cleaning solution through a hose connected to a cleaning solution tank.

As shown in FIG. 3, the spray washer nozzle 10 includes a nozzle body 100. A cleaning solution inlet 110 through which cleaning solution is introduced is formed to one side of a nozzle body 100. A main spray part 120 through which the cleaning solution is sprayed is formed at the other side of the nozzle body 100.

A split part 130 for splitting cleaning solution and a sub spray part 140 are formed to the nozzle body 100, and a guiding part 150 for guiding flow of the cleaning solution is formed between the split part 130 and the cleaning solution inlet 110.

The cleaning solution inlet 110 is formed in a circular shape, and supplies to the nozzle body 100 the cleaning solution which has been supplied through the housing 1. Since the cleaning solution inlet 110 has a circular shape, the cleaning solution can be uniformly spread toward the nozzle body 100.

The main spray part 120 is formed at an end of the nozzle body 100 opposite to the cleaning solution inlet 110. The width of the main spray part 120 is designed to be greater than that of the sub spray part 140. However, the width of the main spray part 120 is formed to be slightly less than or substantially equal to a value obtained by summing the widths of the two sub spray parts 140. The reason for this is to maintain the spray pressure and spray speed of the cleaning solution which is sprayed through the main spray part 120.

The split part 130 is formed between the cleaning solution inlet 110 and the main spray part 120, and is formed to have a shape of a semicircle which is indented toward the cleaning solution inlet 110.

The flow of the cleaning solution is partially blocked off by the split part 130, and the cleaning solution having collided with the split part 130 moves toward both ends of the split part 130 along the shape of the split part 130. A narrow flow passage is formed in a region between the split part 130 and both sides of the nozzle body 100, and the speed and the pressure of flow of the cleaning solution are increased in the region.

The region forms the sub spray part 140 which enables the cleaning solution to be sprayed at a high speed. For this, it is preferable that the width of the nozzle body 100 is designed to become gradually narrow toward the split part 130.

The cleaning solution having passed the sub spray part 140 flows into the main spray part 120 while maintaining its speed and pressure. The cleaning solution having flowed into the main spray part 120 is sprayed onto a front windshield glass of a vehicle.

As explained above, the guiding part 150 is formed between the cleaning solution inlet 110 and the split part 130. The guiding part 150 is provided in a pair and has a elliptical shape. It is formed to be slanted at both sides of the cleaning solution inlet 110 (see FIG. 3). It serves to guide the cleaning solution which has been flowed therein through the cleaning solution inlet 110 toward both ends of the nozzle body 100.

Preferably, a sub guiding part (not shown) can be formed to further enhance the function of the guiding part 150. The sub guiding part can be formed, for example, between the split part 130 and main spray part 120. Preferably, it is positioned so as not to block the flow of the cleaning solution that has passed the sub spray part 140. The sub guiding part guides the flow of the cleaning solution such that the cleaning solution is flowed into the main spray part 120 while the speed and pressure of the cleaning solution are maintained.

The cleaning solution which has been introduced through the cleaning solution inlet 110 is sent to both sides of the nozzle body 100 by the guiding part 150 and the split part 130. The speed and pressure of the cleaning solution are increased while the cleaning solution passes through the sub spray part 140 with a narrow width. The cleaning solution is sent to the main spray part 120 while the flow speed and pressure of the cleaning solution are increased by the guiding part 150, and is then sprayed toward the outside of the spray washer nozzle 10.

Since the cleaning solution is sprayed in a state at which the flow speed and pressure are increased, the cleaning solution can be uniformly sprayed in a wide range, thereby enhancing the overall cleaning performance. In addition,

since the spray washer nozzle is integrally formed with the housing, the spray washer nozzle structure becomes simple and the manufacturing costs can be reduced accordingly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A spray washer nozzle structure comprising:
a housing installed to a hood panel or a cowl top cover of a vehicle; and
a spray washer nozzle integrally formed with the housing for supplying toward the windshield glass of a vehicle a cleaning solution received from the housing.

2. The spray washer nozzle structure of claim 1, wherein the spray washer nozzle comprises:
a nozzle body in which the cleaning solution flows;
a cleaning solution inlet formed at a side of the nozzle body for introducing the cleaning solution into the nozzle body; and
a main spray part formed at the other side of the nozzle body opposite to the cleaning solution inlet for spraying the cleaning solution.

3. The spray washer nozzle structure of claim 2, wherein the spray washer nozzle further comprises a split part formed in a shape of a semicircle between the cleaning solution inlet and the main spray part for splitting the cleaning solution to both sides of the nozzle body.

4. The spray washer nozzle structure of claim 3, wherein the spray washer nozzle further comprises a sub spray part formed between the split part and both sides of the nozzle body.
